(19) United States
(12) Patent Application Publication
(10) Pub. No.: US 2025/0199778 A1
(43) Pub. Date: Jun. 19, 2025

(54) IMPLEMENTING REFLECTION MECHANISM IN BLOCKCHAIN

(71) Applicant: Ant Blockchain Technology (Shanghai) Co., Ltd., Shanghai (CN)

(72) Inventor: Wei Zhou, Hangzhou (CN)

(73) Assignee: Ant Blockchain Technology (Shanghai) Co., Ltd., Shanghai (CN)

(21) Appl. No.: 19/066,988

(22) Filed: Feb. 28, 2025

Related U.S. Application Data
(63) Continuation of application No. PCT/CN2022/135332, filed on Nov. 30, 2022.

(30) Foreign Application Priority Data
Aug. 31, 2022 (CN) 202211066052.X

(51) Int. Cl. G06F 8/41; G06F 9/448; G06F 9/455

(52) U.S. Cl. CPC G06F 8/41; G06F 9/449; G06F 9/45504

(57) ABSTRACT

Methods, apparatuses, and computer-readable media for implementing a reflection mechanism in a blockchain are described. In an example process, a compiler compiles contract source code comprising reflective programming into a Wasm file. The compiler generates metadata of a first type and a first function in the first type, and packages the metadata in the Wasm file; and generates contract bytecode of a second function that obtains a first function type and first function content according to dynamic parameters. After receiving a transaction that calls a contract, a virtual machine loads the Wasm file, uses the metadata in the Wasm file to initialize a part of a memory in a created linear memory region; and parses and executes the contract bytecode in the Wasm file. When executing the bytecode of the second function, the virtual machine determines and executes, based on the metadata, the first function in the linear memory region.

### CROSS-REFERENCE TO RELATED APPLICATIONS

This application is a continuation of PCT Application No. PCT/CN2022/135332, filed on Nov. 30, 2022, which claims priority to Chinese Patent Application No. 202211066052.X, filed on Aug. 31, 2022, and each application is hereby incorporated by reference in its entirety.

### TECHNICAL FIELD

Embodiments of this specification belong to the field of blockchain technologies, and in particular, to a method for implementing a reflection mechanism in a blockchain, a compiling method, a compiler, and a Wasm virtual machine.

### BACKGROUND

Blockchain is a novel application mode of distributed data storage, peer-to-peer transmission, consensus mechanism, encryption algorithm, and other computer technologies. The emergence of smart contracts in the blockchain 2.0 era raises the application scope of blockchain to a new level. With the smart contracts, the blockchain can no longer conduct a single transfer transaction, but can also call a segment of code, and the segment of cod can be customized by a user.

### SUMMARY

The purpose of this specification is to provide a method for implementing a reflection mechanism in a blockchain, a compiling method, a compiler, and a Wasm virtual machine.

A method for implementing a reflection mechanism in a blockchain includes: in a process that a compiler compiles contract source code that comprises reflective programming into a Wasm file: according to code that defines a first type in the source code/bytecode, generating metadata of the first type and a first function in the first type, and packaging the generated metadata of the first type and the first function in the first type in the Wasm file; and according to reflection code in the source code, generating contract bytecode of a second function that obtains a first function type and first function content according to dynamic parameters during running; after receiving a transaction that calls a contract, a virtual machine loading a Wasm file of the called contract, and creating a linear memory region; using the metadata in the Wasm file to initialize at least a part of a memory in the linear memory region; and parsing and executing the contract bytecode in the Wasm file and when executing the bytecode of the second function, according to the dynamic parameters for function calling in the transaction that calls the contract, determining and executing, on the basis of the metadata, the called first function in the linear memory region.

A compiling method includes: in a process that a compiler compiles contract source code that includes reflective programming into a Wasm file: according to code that defines a first type in source code/bytecode, generating metadata of the first type and a first function in the first type, and packaging the generated metadata of the first type and the first function in the first type in the Wasm file; and according to reflection code in the source code, generating contract bytecode of a second function that obtains a first function type and first function content according to dynamic parameters during running.

A method for executing the Wasm file compiled by the preceding compiling method by a Wasm virtual machine includes the Wasm virtual machine loading a Wasm bytecode of the called contract, and including creating a linear memory region; using the metadata in the Wasm file to initialize at least a part of a memory in the linear memory region; and parsing and executing the contract bytecode in the Wasm file and when executing the bytecode of the second function, according to the dynamic parameters for function calling in the transaction that calls the contract, determining and executing, on the basis of the metadata, the called first function in the linear memory region.

A compiler includes: a metadata generating unit, configured to generate, according to code that defines a first type in source code/bytecode, metadata of the first type and a first function in the first type; a packaging unit, configured to package the metadata of the first type and the first function in the first type generated by the metadata generating unit in the Wasm file; and a second function contract bytecode generating unit, configured to generate, according to reflection code in the source code, contract bytecode of a second function that obtains a first function type and first function content according to dynamic parameters during running.

A Wasm virtual machine is configured to execute the Wasm file complied by the preceding compiler, and includes: a loading unit, configured to load a Wasm bytecode of the called contract, and including: a creating unit, configured to create a linear memory region; a first initializing unit, configured to use the metadata in the Wasm file to initialize at least a part of a memory in the linear memory region; and an execution unit, configured to parse and execute the contract bytecode in the Wasm file and when executing the bytecode of the second function, according to the dynamic parameters for function calling in the transaction that calls the contract, determine and execute, on the basis of the metadata, the called first function in the linear memory region.

A blockchain node for executing a smart contract includes the Wasm virtual machine or executes the aforementioned method.

A blockchain node for executing a smart contract includes: a processor, and a memory storing a program. When the processor executes the program, the method above is executed.

In the embodiments above, a reflection function can be implemented in the Wasm file, such that when a Wasm program is running, capabilities such as accessing, detecting, and modifying own states or behaviors can be implemented. This is particularly useful when there are multiple functions, as it allows developers to easily and flexibly use reflection to call different functions while developing the contract.

### BRIEF DESCRIPTION OF DRAWINGS

In order to more clearly state the technical solutions in the embodiments of this specification, the accompanying drawings required to be used in the embodiments are briefly introduced below. Obviously, the accompanying drawings described below are only some embodiments of this specification. For persons having ordinary skill in the art, without involving creative labor, other accompanying drawings can also be obtained from these accompanying drawings.

FIG. 1 is a schematic diagram of creating and deploying a smart contract in a blockchain network in an embodiment.

FIG. 2 is a schematic diagram of creating, deploying, and calling a smart contract in a blockchain network in an embodiment.

FIG. 3 is a schematic diagram of creating, deploying, and calling a smart contract in a blockchain network in an embodiment.

FIG. 4 is a schematic diagram of a bytecode structure and a virtual machine module in an embodiment.

FIG. 5 is a flow chart of a method for implementing a reflection mechanism in an embodiment.

FIG. 6 is a schematic diagram of a principle for implementing a reflection mechanism in an embodiment.

FIG. 7 is a schematic diagram, i.e., a relationship diagram, of a table in a linear memory and a table in a normal memory in an embodiment.

FIG. 8 is a schematic diagram of a Wasm virtual machine module in an embodiment.

### DETAILED DESCRIPTION

In order to enable persons skilled in the art to better understand the technical solutions in this specification, the technical solutions in embodiments of this specification would be clearly and completely described in combination with the attached drawings in the embodiments of this specification. Obviously, the described embodiments are only partial embodiments of this specification, not all embodiments. On the basis of the embodiments in this specification, all other embodiments obtained by persons having ordinary skill in the art without creative work shall fall within the scope of protection of this specification.

The blockchain 1.0 era usually refers to a development stage of blockchain applications represented by Bitcoin between 2009 and 2014, which mainly focuses on solving the problem of decentralization of currency and payment means. Beginning in 2014, developers increasingly focus on addressing Bitcoin's technical and scalability shortcomings. At the end of 2013, Vitalik Buterin released an Ethereum white paper “Ethereum: Next Generation of Smart Contracts and Decentralized Application Platform”, which introduced smart contracts into the blockchain and opened an application of blockchain outside the currency field, thus opening the era of blockchain 2.0.

The smart contract is a computer contract that can be automatically executed based on stipulation triggered rules, which can also be regarded as a digital version of a traditional contract. The concept of smart contracts was first proposed by Nick Szabo, an interdisciplinary legal scholar and cryptography researcher, in 1994. This technology was once not used in a real industry due to the lack of programmable digital systems and related technologies, until the emergence of blockchain technology and Ethereum, which provided a reliable execution environment. Due to a block chain ledger adopted by the blockchain technology, data generated cannot be tampered with or deleted, and data would be continuously added to the entire ledger, thus ensuring the traceability of historical data. At the same time, the decentralized operation mechanism avoids the influence of centralized factors. The smart contract based on the blockchain technology can not only give full play to advantages of smart contracts in terms of costs and efficiency, but also avoid interference of malicious behaviors on normal execution of the contracts. The smart contract is written into the blockchain in a digital form, and characteristics of the blockchain technology ensure that whole processes of storage, reading, and execution are transparent and traceable, and cannot be tampered with.

The smart contract is essentially a program that can be executed by a computer. The smart contract, like today's widely used computer programs, can be written in high-level languages. For example, Ethereum and some Ethereum-based alliance chains would generally provide native smart contracts written in high-level languages such as Solidity, Serpent, and LLL. The smart contracts written in these high-level languages can include various complex logics to achieve various service functions. The core of Ethereum as a programmable blockchain is the Ethereum Virtual Machine (EVM), which can be run by every Ethereum node. The EVM is a Turing-complete virtual machine, which means that various complex logics can be implemented through it. A user publishing and calling the smart contract in Ethereum can run on the EVM. In fact, the virtual machine directly runs virtual machine code (virtual machine bytecode, or “bytecode”). The smart contracts deployed on the blockchain can be in the form of bytecode.

In addition, as a decentralized distributed system, the blockchain needs to maintain distributed consistency. Specifically, each node in a group of nodes in the distributed system is provided with a state machine therein. Each state machine needs to execute same instructions in a same order from a same initial state, keeping each state change the same, so as to ensure that a final consistent state is reached. However, it is difficult for each node device participating in a same blockchain network to have the same hardware configuration and software environment. Therefore, in Ethereum, the representative of blockchain 2.0, in order to ensure that the process and result of the execution of the smart contract on each node are the same, a Virtual Machine similar to the JVM, i.e., a Ethereum Virtual Machine (EVM), is used. Differences in hardware configuration and software environment of each node can be shielded by EVM, and sandbox-like environments of the EVM can also ensure that the execution of the smart contract would not affect blockchain platform codes, other programs, or operating systems on a host. In this way, the developers can develop a set of codes of the smart contract, and upload the compiled bytecode to the blockchain after the developers compiles the codes of the smart contract locally. After each node executes the same bytecode through the same EVM at the same initial state, the same final result and the same intermediate result can be obtained, and underlying hardware and environment differences of different nodes can be shielded.

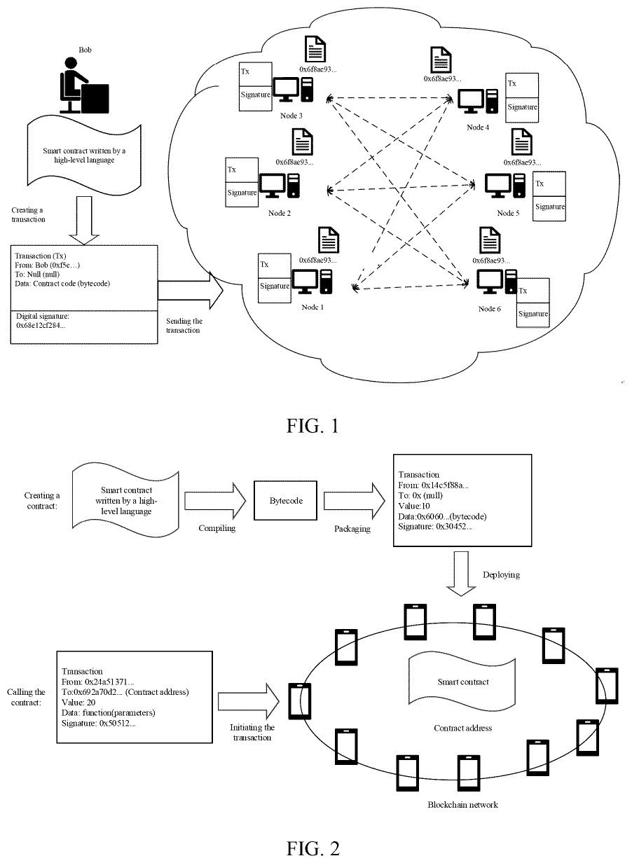

For example, as shown in FIG. 1, after Bob sends a transaction comprising creation of smart contract information to the Ethereum network, the EVM of node 1 can execute the transaction and generate the corresponding contract instance. The data field of the transaction can store the bytecode of the contract, and the to field of the transaction can be an empty address. After the nodes reach consensus through the consensus mechanism, the smart contract can be successfully created on the blockchain. “0x6f8ae93 . . . ” in FIG. 1 represents the address of the successfully created smart contract, through which subsequent users can call the contract. After the contract is created, a contract account corresponding to the contract address of “0x6f8ae93 . . . ” appears on the blockchain, the contract code and the account storage can be stored in the contract account. The behavior of the smart contract is controlled by the contract code, while the account storage of the smart contract preserves the state of the contract. In other words, the smart contract enables the generation of a virtual account on the blockchain that includes the contract code and account storage.

As mentioned above, a data field including creation of a transaction of a smart contract can store the bytecode of this smart contract. The bytecode consists of a sequence of bytes, each byte can indicate an operation. On the basis of development efficiency, readability, and other considerations, developers can not directly write bytecode, but choose a high-level language to write the smart contract code. The smart contract code written in the high-level language is compiled by a compiler to generate bytecode, which can then be packaged into the initiated transaction and deployed on the blockchain through the aforementioned consensus and execution process, as shown in FIG. 2.

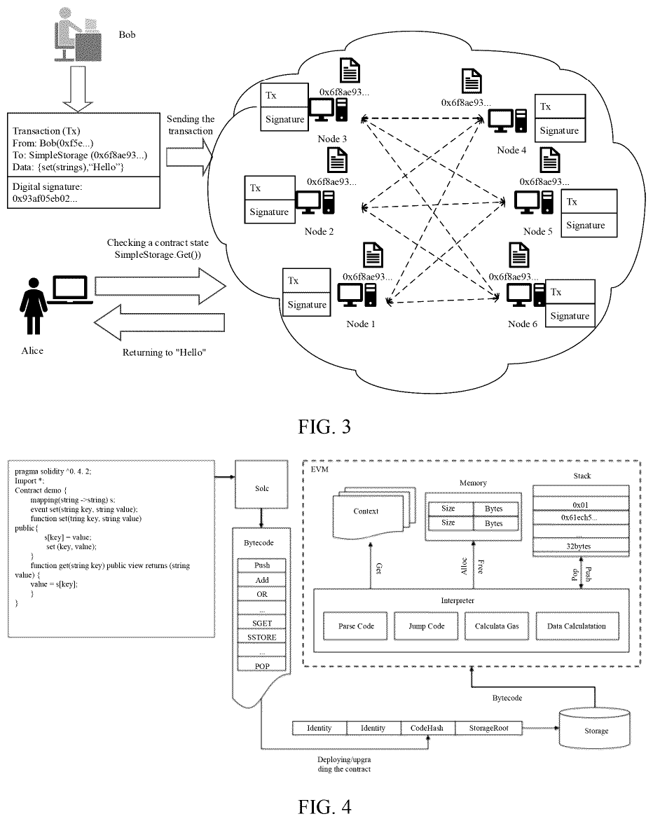

As shown in FIGS. 2 and 3, still taking Ethereum as an example, after Bob sends a transaction including calling information of the smart contract to the Ethereum network, the EVM of node 1 can execute this transaction and generate a corresponding contract instance. A from field of the transaction in FIG. 3 is an address of an account that initiates the calling of the smart contract, “0x6f8ae93 . . . ” in a to field represents an address of the called smart contract, a value field is a value of ether in Ethereum, and a data field of the transaction stores the method and parameter of the called smart contract. After calling the smart contract, a value of balance may be changed. Then, a certain client may check a current value of the balance through a certain blockchain node. The smart contract can be executed independently by each node in the blockchain network in a prescribed way, and all execution records and data are stored on the blockchain. Hence, when such transactions are completed, transaction vouchers that cannot be tampered with and cannot be lost are stored on the blockchain.

As mentioned above, the transaction for creating a smart contract is sent to the blockchain, and after consensus, each node of the blockchain can execute the transaction. Specifically, the EVM virtual machine of the blockchain node can execute the transaction. At this time, a contract account corresponding to the smart contract appears on the blockchain (including, such as an identity, Identity, of the account, a hash value, Codehash, of the contract, and a root, StorageRoot, of the contract storage), and has a specific address. The contract code and account storage can be stored in the storage of the contract account, as shown in FIG. 4. The behavior of the smart contract is controlled by the contract code, while the account storage of the smart contract preserves the state of the contract. In other words, the smart contract enables the generation of a virtual account on the blockchain that includes the contract code and account storage. For a contract deployment transaction or a contract update transaction, the value of Codehash will be generated or changed. Subsequently, the blockchain node can receive a transaction request calling the deployed smart contract, and the transaction request can include the address of the called contract, the function in the called contract, and the input parameters. Generally, after the transaction request reaches consensus, each node of the blockchain can independently execute the specially called smart contract.

The left side of FIG. 4 shows an example of a smart contract written in solidity. The smart contract is compiled by a compiler to generate bytecode. solc in the drawing is a solidity's command-line compiler. The Ethereum smart contract compiled by solidity can be compiled by solc, a command-line tool with parameters, to generate the bytecode that can be run on the EVM. After the process of deploying the contract in FIGS. 1 and 2 above, the smart contract can be successfully created on the blockchain. After the contract is deployed, a contract account corresponding to the smart contract appears on the blockchain. The contract account includes, such as an identity, Identity, of the account, a hash value, Codehash, of the contract, and a root, StorageRoot, of the contract storage, and has a specific address. The contract code and account storage can be stored in the storage of the contract account. Codehash is generally the hash value of the contract bytecode. After the contract is deployed, Codehash is the hash value of the contract bytecode. When the contract is updated, the hash of the contract bytecode would generally change, and Codehash would also generally be updated.

The execution of the contract can be specifically shown in FIG. 4. For example, a transaction for calling the contract is sent to the blockchain network, and after consensus, each node can execute the transaction. The to field of the transaction indicates the address of the called contract. Any node can find the storage of the contract account according to the address of the contract, and then can read the Codehash from the storage of the contract account, so as to find the corresponding contract bytecode according to the Codehash. The node can load the bytecode of the contract from the storage to the virtual machine. Furthermore, it is interpreted and executed by an interpreter, for example, including: parsing the bytecode of the called contract (Parse, such as Push, Add, SGET, SSTORE, and Pop), to obtain OPcode and functions, storing these OPcode to a memory opened by the virtual machine (alloc, after the program is executed, a corresponding memory releasing operation, for example, Free in the drawing), and at the same time, also obtaining a JumpCode of the called function in the memory. Generally, after calculating the Gas needed to be consumed for executing the contract and Gas being sufficient, it is jumped to the corresponding address of Memory to obtain the OPcode of the called function and start to execute. Data Computation, push/push Stack and other operations are performed on the data operated by the OPcode of the called function, to complete the data computation. In this process, some contract context information may also be needed, such as the block number, and information of an initiator for calling the contract; the information can be obtained from the Context (Get operation). Finally, the generated state is stored in a database storage by calling a storage interface. It should be noted that in the process of contract creation, it may also produce the execution of some functions in the contract, for example, the function of an initialization operation. At this time, the code will also be parsed, the jump instructions will be generated, the Memory will be stored, the data will be operated in the Stack, etc.

In fact, C language, C++ language, Java language, Go language, Python language, and other high-level languages also have some advantages. For example, C language is more efficient; C++ and Java have a wide audience, a large number of developers, and mature communities and tools. Go language is more modern; Python language is relatively simple to use. At present, all blockchain platforms are extending smart contract types to smart contracts supporting development by high-level languages such as C, C++, Java, Go, and Python languages. After extending to the smart contracts supporting development by the high-level languages, one implementing mode is to compile contract bytecodes in a wasm (WebAssembly) format. The WebAssembly is an open standard developed by a W3C community group, is a secure, portable low-level code format specially designed for efficient execution and compact presentation, can run with near-native performances, and provides a compilation target for languages such as C, C++, Java, and Go. Originally designed purpose of the WASM virtual machine is to solve the growing bad performance problems of Web applications. The WASM virtual machine has been adopted by an increasing number of non-Web items due to its superior characteristics, such as replacing the smart contract execution engine EVM. The WebAssembly virtual machine (which also known as the Wasm virtual machine or Wasm running environment, and is the virtual machine running environment for executing the WASM bytecode) implemented according to the W3C community open standards is implemented by means of loading the Wasm bytecode during running and interpreting the execution. The execution process of the Wasm bytecode in the Wasm virtual machine is also similar to the EVM process described above, as shown in FIG. 4.

For example, using the smart contract edited by C++ language, after the smart contract is written by the contract developer, a corresponding source file can be generated, which is generally a source file with an extended name .cpp. The .cpp file of the contract code can be compiled by the compiler to generate byte-code in a Wasm format. The contract bytecode in the Wasm format can be packaged in the wasc file. Similarly, for the smart contract edited in Java language, the contract developer can generate a corresponding source file after writing the smart contract, which is generally a source file with an extended name .java. The java file of the contract code can be compiled by the compiler to generate bytecode in the Wasm format. The contract bytecode in the Wasm format can be packaged in the wasc file. The wasc is a file that combines bytecode and an Application Binary Interface (ABI).

Behaviors of programs developed in different high-level languages may be different due to different characteristics of these high-level languages. For example, a program developed in Java language can realize the reflection function when run by its corresponding JVM virtual machine because the Java language has a reflection mechanism. The reflection mechanism, also known as reflection programming, refers to an ability of a computer program to access, detect, and modify its own state or behavior during running. The reflection programming function in the Java programming language is a common function, and typically, is capable of supporting dynamic execution, while the WASM bytecode standard does not directly support the reflection function. The high-level languages having the reflection programming function further include C#, Python, Go, and other languages, in addition to Java. Some parts of this specification mainly take Java as an example to illustrate, and of course, it also applies to C#, Python, Go languages, etc.

In the blockchain, the smart contract developed by the developers can provide different functions to achieve different functions, and subsequent contract callers can dynamically call one or some functions in the contract to achieve specific functions. For the high-level programming languages that do not support reflection functions, it is generally necessary for the developers to explicitly write conversion of method names to method callings involved in calling different functions in the code when developing the contract. The code is cumbersome and lengthy. For the high-level programming languages that support reflection, the developers can use the reflection function to flexibly and easily implement the conversion of method names to method callings involved in calling different functions in the code when developing the contract.

For example, in the high-level language such as C++, which does not support reflection programming, if it is to achieve dynamic execution, it is generally executed dynamically according to the needs by means of a branch structure. For example, the following C++ program simulates the dynamic execution of different methods:

| | |
|---|---|
| 1 | int invokeMethod(string func, int arg1, int arg2) { |
| 2 | if(func == “sum”) { |
| 3 | return arg1 + arg2; |
| 4 | } |
| 5 | if (func == “multiply”) { |
| 6 | return arg1 * arg2; |
| 7 | } |
| 8 | ... |
| 9 | ... |
| 10 | printf(“not found”); |
| 11 | return 0; |
| 12 | } |

### Code Segment: 1

Code segment 1 above in the C++ contract provides functions such as sum and multiply for a contract caller to initiate a call and input parameters. Because the contract cannot know in advance which specific function in the contract will be called by the initiated transaction that calls the contract, a if branch is usually used for matching the initiated contract calling. After matched, the corresponding parameter is input to execute the function and return the result. This way is to simulate a dynamic execution manner, and for more functions in the contract, this part of codes is more tedious and lengthy.

The codes for similar function, such as in Java, can be implemented by a reflection mechanism:

| | |
|---|---|
| 1 | Class Person { |
| 2 | string name; |
| 3 | int age; |
| 4 | ... |
| 5 | int getSum(int a, int b) { return a + b; } |
| 6 | int getMultiply(int a, int b) { return a * b; } |
| 7 | ... |
| 8 | } |
| 9 | ... |
| 1 | int getProperty(Object p, String prop, int arg1, int arg2) { |
| 1 | String methodName = “get” + prop; |
| 1 | Method<?> method = p.getClass( ).getMethod(methodName, int.class, |
| | int.class); |
| 1 | return (Integer) method.invoke(p, arg1, arg2); |
| 1 | } |

### Code Segment 2

In the Java code above, lines 1-8 define a class named Person. This class includes at least two member variables and at least two member functions, the two member variables are respectively name and age, and respectively are strings and integers, respectively. The first function is getSum( ) and the second function is getMultiply( ). The input parameters of getSum( ) and getMultiply( ) are both integer variables, with the former returning the sum of the two parameters and the latter returning the product of the two parameters. In addition to the Person class, ellipses on line 9 can indicate that other classes are defined, and these defined classes can also include member variables/member functions. Lines 10-14 define a function named getProperty, which means an obtaining attribute, and the input parameters include an object p of the Object type, a variable prop of the string type, and integer variables arg1 and arg2. In a specific implementation of the getProperty( ) function, the function name can first be dynamically obtained through line 11. For example, the user initiates a call to a contract, which specifically may be calling a function such as getSum( ) or getMultiply( ) in the contract. For example, the interface functions provided to the user are Sum( ) and Multiply( ), respectively. Before the contract is executed, it is not possible to predict which function in which class object will be called by the transaction initiated by the user to call the contract. In this way, the reflection mechanism code on lines 12-13 above provides a flexible and easy conversion from the method name to method call. Specifically, for example, in the above-mentioned example, line 10 defines an Object p created by a superparent Object (class such as Person inherits from Object class, so the ancestor class of the object created by the Person class is the Object, and Object is also called an ancestor class) in the input parameter. Line 11 extracts the name of the function called by the user and splices with “get” at the front to get the full function name. Line 12 includes a reflection function function, i.e., through p.getClass( ).getMethod(methodName, int.class, int.class), obtaining the function having the same function name and the same input parameter and output parameter (or return type) (the function name and the input parameter and output parameter are also referred to as function signatures) in the class to which the object p belongs (including other subclasses inherited from the Object class, such as Person) through p.getClass( ).getMethod(methodName, int.class int.class). In the code on line 13, the taken function is used for completing the calculation and returning the calculation result. The specific implementations of the reflection code on lines 12 and 13 in the compiler and the virtual machine are detailed below. In this way, particularly for the condition of having a plurality of functions, it is unnecessary to match each function name like the multi-conditional branch structure used for simulating dynamic execution in the C++ code above.

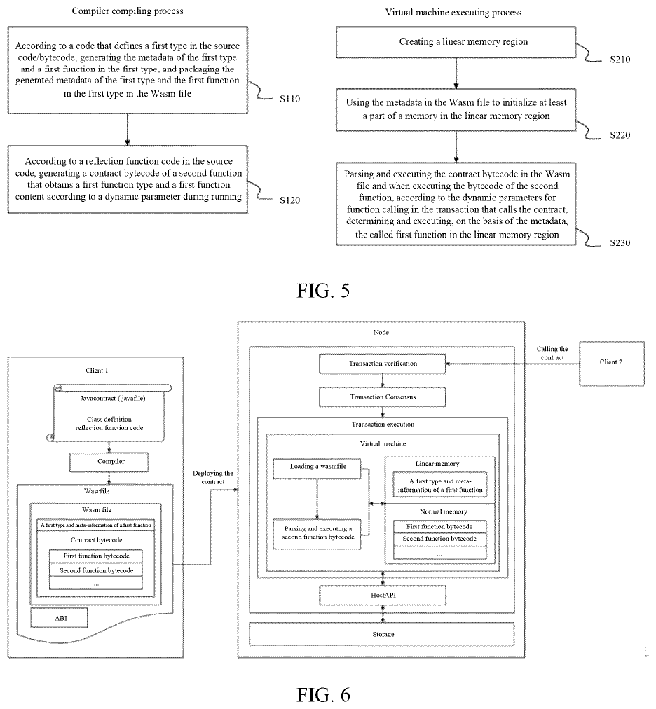

For the smart contract written by the developers in Java, the reflection mechanism may already be included. To enable the Wasm virtual machine to implement the reflection function when executing the compiled Wasm file, the compiler can perform the process shown in FIGS. 5 and 6 while compiling the Java source code into the Wasm file.

S110: according to code that defines a first type in the source code/bytecode, generate metadata of the first type and a first function in the first type, and package the generated metadata of the first type and the first function in the first type in the Wasm file.

For example, in the Java source code, the type can be defined (generally also referred to as the class), for example, Class Person { . . . } in the Java code above. { . . . } may include a member variable and a member function. One Java file can define multiple classes, and each class may define multiple member functions. For each member function, it may generally include a return type, a function name, an input parameter, etc. These types may be uniformly referred to as the first type, and these member functions may be uniformly referred to as the first function. “First” herein can be understood as “first type” or “first class”. On the basis of defining the class, an object can be generated based on the class. Using classes and objects is a major means for object programming. The object is an abstraction of an objective substance; and the class is an abstraction of the object. The relationship therebetween is the object is an instance of the class, and the class is a template of the object.

The metadata of the first type and the first function may be packaged in the Wasm file. The metadata of the first type and the first function at least may include a structure of a first type object and a structure of the first function. Since all are objects in Java, and a type is also a special object, for a special object such as a type, it also has its own type and field. This first type object can then be used for finding the type to which it belongs. In addition, it may further includes a first type structure and/or a field structure of a first type. Whether to include the first type structure and the field structure of the first type depends on a compiler's compilation solution, and may also depend on whether the field of the first type is used in the first function, for example, the implementation in the first function needs to use one or some fields in the first type. In a specific example, the metadata of the first type and the first function may include a structure of a first type object, a first type structure, a field structure of the first type, the structure of the first function, etc., specifically, for example:
-the structure of the first type object;
--a linear memory address of a object type in 4 bytes; and
--a linear memory address of each field array of an object;
-the first type structure:
--a linear memory address of a type name character string in 4 bytes;
--a linear memory address of a field array of a type in 4 bytes; and
--a linear memory address of a method function array of a type in 4 bytes;
-the field structure of the first type:
--a field number of a type in 4 bytes;
--a linear memory address of a field name character string in 4 bytes; and
--a linear memory address of a return type of a field in 4 bytes;
-the function structure of the first type:
--a method function number of a type in 4 bytes;
--an index of a function in a function table in 4 bytes;
--a linear memory address of a function name character string in 4 bytes;
--a linear memory address of a function return type in 4 bytes;
--a parameter number of a function in 4 bytes; and
--a linear memory address of a type array of each parameter.
. . .

In the metadata above, front “-” represents a first level, “--” represents a second level, and the second level is subordinate to the last closest first level.

The metadata of the first type and the first function in the first type may be packaged in the Wasm file.

Particularly, after subsequently loaded by the Wasm virtual machine, the metadata can be loaded to the linear memory managed by the Wasm virtual machine. The linear memory managed by the Wasm virtual machine has a logic address, rather than a logic address in a system memory. Herein, in the process of packaging the metadata in the Wasm file, the logic address of the linear memory where the metadata is located can be determined. In addition, the virtual machine can further manage the a non-linear memory, i.e., the normal memory referred to hereinafter.

The Wasm virtual machine implements at least a part of sandboxes and deterministic goals through the linear memory. First, the memory addresses in the Wasm file are all in the range of 0 to the linear memory capacity, and would not exceed this linear memory region. This ensures that the Wasm bytecode, when executed by the virtual machine, would not read the memory outside the Wasm managed linear memory, that is, any external information would not be read at all, unless called through the HostAPI. Hence, the reading and writing of all Wasm instructions are the addresses of the accessed linear memory, and no boundaries can be crossed, thereby achieving the sandbox goal. Secondly, the various metadata of the classes (i.e., types) in the Wasm file in the context of this specification is determined during compiling, especially the logic addresses of the classes and the member variables and member functions in the classes in the context of this specification in the linear memory are also determined. Therefore, the process of loading the same contract Wasm file through the Wasm virtual machine on different nodes and executing the contract bytecode therein can ensure that each metadata in the class is consistent, and specifically, the logic addresses of the class and the member variables and member functions of the class in the linear memory are also consistent (even various information generated based on the logic address is also consistent, and it would not be different because of the random nature of the normal memory), that is, it will not cause the execution results of the same contract bytecode in the Wasm virtual machines of different nodes to be inconsistent due to small differences, so as to achieve the deterministic goal.

On the contrary, if the C++ code is executed directly without the use of the Wasm virtual machine, it will be inconsistent due to memory randomness. Not only will the running results of different nodes be inconsistent, but also the results would be inconsistent even if the same node executes the same program multiple times. For example, the operation of creating an object with the new sentence according to the class definition; for each execution, the generated object memory address is likely to be different, because the memory address is generally randomly assigned by the operating system according to the memory situation. If the program logic includes the calculation of some subsequent contents based on this address, it will lead to inconsistent execution results. For another example, in a partial implementation of the hash table, the hash would be calculated according to the address of the object, which will also cause the hash table to be stored in an inconsistent order, and if there is a subsequent traversal operation of the hash table, the order will also be inconsistent.

By combining the aforementioned Java source code, the metadata of the first type and the first function may be as follows:

TABLE 1
type structure

| The structure of the type in the Wasm | Example for explanation (an address is represented |
|---|---|
| linear memory | using hexadecimal) |
| an object structure: | Starting address: 0x01020300 |
| a linear memory address of an object | 0X01020304//4 bytes, which is, for example, an |
| type in 4 bytes; | address of Class |
| a type structure: | Starting address: 0x01020304 |
| a linear memory address of a type | 0x000a0b00//4 bytes, for example, an address of |
| name character string in 4 bytes; | the character string of “Person” in the linear |
| a linear memory address of a field | memory, which is an address of a type name |
| array of a type in 4 bytes; and | 0x0a0203ab//4 bytes, which is a linear memory |
| a linear memory address of a method | address, and a starting address of a field array in a |
| function array of a type in 4 bytes; | storage type |
| | 0x0a020336//4 bytes, which is a linear memory |
| | address, and a starting address of a method function |
| | array of a storage type |
| a field array structure of a type: | Starting address: 0x010203ab |
| a field number of a type in 4 bytes; | 0x00000002//4 bytes, a field number in a type, |
| a linear memory address of a field 1 | which is assumed to be 2, for example, two fields, |
| name character string in 4 bytes; | i.e., name and age, in the code |
| a linear memory address of a return | 0x0c0c0d01//4 bytes, which is an address of the |
| type of a field 1 in 4 bytes; | character string of “name” in the linear memory, for |
| a linear memory address of a field 2 | example, the name of the name field in this address |
| name character string in 4 bytes; | 0x00030201//4 bytes, which is a starting address of |
| a linear memory address of a return | a String type in the linear memory, and is, for |
| type of a field 2 in 4 bytes; | example, a return type of the name field since |
| | String itself is also a type |
| | 0x0c0d0a03//4 bytes, which is an address of the |
| | character string of “age” in the linear memory, and |
| | is the name of the age field |
| | 0x00000001//4 bytes, which represents a basic type |
| | int, and is a return type of the age field |
| a method function array structure of a | Starting address: 0x01020430 |
| type: | 0x00000002//4 bytes, which is a method number in |
| a method function number of a type in | a type, and is 2 herein, for example, two functions |
| 4 bytes; | getSum( ) and getMultiply( ) |
| an index of a function 1 in a Wasm | 0x00000001//4 bytes, which is an index of a |
| function table in 4 bytes; | Person.getSum( ) method in the function table in |
| a linear memory address of a function | Wasm, the index being assumed to be 1 herein |
| 1 name character string in 4 bytes; a | 0x0d010502//4 bytes, which is an address of the |
| linear memory address of a function 1 | character string of “getSum” in the linear memory, |
| return type in 4 bytes; | and is the name of the getSum method |
| a parameter number of a function 1 in | 0x00000001//4 bytes, which represents a basic type |
| 4 bytes; | int, and is a return type of the getSum( ) method |
| a linear memory address of a type | 0x00000002//4 bytes, which is a parameter number |
| array of each parameter of a function 1; | of a function, and is 2 herein, for example, two |
| an index of a function 2 in a Wasm | parameters |
| function table in 4 bytes; | 0x03040a0d//4 bytes, which is a linear memory |
| a linear memory address of a function | address, for example, the parameter type array of |
| 2 name character string in 4 bytes; | the getSum( ) method |
| a linear memory address of a function | 0x00000002//4 bytes, which is an index of a |
| 2 return type in 4 bytes; | Person.getMultiply( ) method in the function table |
| a parameter number of a function 2 in | in Wasm, the index being assumed to be 2 herein |
| 4 bytes; | 0x0d031522//4 bytes, which is an address of the |
| a linear memory address of a type | character string of “getMultiply” in the linear |
| array of each parameter of a function 2; | memory, and is the name of the getMultiply method |
| an index of a Wasm function of a | 0x00000002//4 bytes, which represents a basic type |
| function 3 in a Wasm function table in 4 | int, and is a return type of the getMultiply( ) method |
| bytes; | 0x007a4792//4 bytes, which is a parameter number |
| . . . | of a storage function, and is 2 herein, for example, |
| | two parameters |
| | 0x04a41242//4 bytes, which is a linear memory |
| | address, and is the parameter type array of the |
| | getMultiply( ) method |
| | 0x0203047d//4 bytes, which is an index of a certain |
| | method in the function table in Wasm, the index |
| | being assumed to be 3 herein |
| | . . . |

It should be noted that each of the 4 bytes above is merely used for giving an example, but is not used for limitation.

In addition, as shown in the table above, the linear memory may further store specific contents in the type structure shown in Table 2 as follows:

TABLE 2
type structure content

| | |
|---|---|
| an object structure: | an object structure: |
| a type; | a type; |
| each field array of an object; | each field array of an object; |
| a type structure: | a type structure: |
| a type name character string; | a type name character string; |
| a field array of a type; | a field array of a type; |
| a method function array of a type; | a method function array of a type; |
| a field array structure of a type: | a field array structure of a type: |
| a field name character string; | a field name character string; |
| a return type of a field; | a return type of a field; |
| a field name character string; | a field name character string; |
| a return type of a field; | a return type of a field; |
| a method function array structure of a type: | a method function array structure of a type: |
| a function 1 name character string; | a function 1 name character string; |
| a function 1 return type; | a function 1 return type; |
| a type array of each parameter of a function 1; | a type array of each parameter of a function 1; |
| a function 2 name character string; | a function 2 name character string; |
| a function 2 return type; | a function 2 return type; |
| a type array of each parameter of a function 2; | a type array of each parameter of a function 2; |
| . . . | . . . |

Hence, addresses in certain fields in the left column in Table 1 refer to certain fields in Table 2. The mapping relationship is detailed later. It should be noted that the memories where each field is located in Table 1 are generally continuous, which facilitates the search for the related structure and field of a same type in the memory. In addition, in four blocks in Table 1, at least the fields in each block are continuous, so that each field is only accessible by a pointer traversal from the starting address in the following code segment 4. Moreover, each field in Table 1 stores the address pointing to each field in Table 2, that is, each field in Table 2 can be found by means of the address in Table 1. Hence, the content of the memory where each field is located in Table 2 is not required to be continuous.

Specifically, in the compiling process, the Wasm function module is processed as follows:

```
  (module
  (Table 1 funcref) //table, which is an array comprising each virtual method
  (func $Person_getSum(result i32)(param i32 i32)...)
  (func $Person_getMultiply(result i32)(param i32 i32 )...)
  (elem(i32.const O) $Person_getSum $Person_getMultiply)// getSum function, which
is placed in the table with an index of 1; getMultiply function is also placed in the table with an
index of 2
  (data 0 “01010101010101”)// representing a data segment of an initial linear memory,
and comprising binary data of the aforementioned type structure)
```

### Code Segment 3

The above-mentioned code segment 3 means that the name character string of the function in the class, the return result type, and the input parameter type are filled in, so that the corresponding fields in Table 2 can be filled in. Moreover, in Table 1, the address of the linear memory where each field of the function of this class is located and the number of the parameters in Table 2 are filled in. At the same time, the index of this class function is created, and an entry corresponding to the index 3 will be established in Table 3. This index is also filled into the corresponding field in Table 1. In this way, for example, the getSum function is placed in the table with an index of 1, and the getMultiply function is also placed in the table with an index of 2.

S120: according to reflection code in the source code, generate bytecode of a second function that obtains a first function type and first function content according to dynamic parameters during running.

As the compiler compiles, support for the reflection code can be added in the source code. The compilation process of the compiler is to organize the structure of the java source code into a suitable format, including lexical/syntactic analysis according to the abstract syntax tree, filling symbols according to the symbol table, annotation processing, semantic analysis, code generation, etc., so as to encode the source code into the Wasm bytecode. In this process, when the compiler compiles the refection function code, bytecode of a second function that obtains a first function type and first function content according to dynamic parameters during running can be generated. For example, in the case of the Java code in the above-mentioned example, lines 12-13 are the reflection code, and the corresponding bytecode is the second function bytecode.

Specifically, to support the reflection code, a reflection library may generally be provided, which includes some classes supporting the reflection function. In the process of writing the source code, according to grammar rules, the developers may import the reflection library to the header of the class file, for example, importing through an import sentence. When compiling the source code by the compiler, related sentences in the reflection library can be used for replacing the reflection code in the item file, so as to conduct the aforementioned processes of lexical/syntactic analysis, filling symbols, annotation processing, semantic analysis, code generation, etc., so as to generate the contract bytecode in the Wasm file.

The imported reflection library, for example, includes specific implementations of Class.getMethod( ) and Method.invoke( ) from lines 12 and 13 above. In this way, during compiling, the reflection code involved in the source code, i.e., the Class.getMethod( ) and Method.invoke( ) method on lines 12 and 13, can be replaced by the corresponding specific implementations in the reflection library.

The provided reflection library includes specific implementations of Class.getMethod( ) and Method.invoke( ).

The method for implementing Class.getMethod( ) is, for example, as follows:

```
class Class {
  // a main principle is for type information, a method metadata array of the type
closely follows the Wasm linear memory
  public Method[ ] getDeclaredMethods( ) {
    // obtaining, from methodIndex array after a class type, an index of the class
to each method function
    // castType is a type conversion function, and during Wasm operation, each
object is an address in an int32 format
    RuntimeClass runtimeClass = castType(this);
    // according to the size of the structure of the storage class, rapidly find the
method list array following the class structure
    int runtimeClassStructureSize = runtimeClass.classStructureSize;
    // obtaining a starting address of the method address array of the type
    Address runtimeClassMethodIndexArrayAddress = Address.ofObject(
      runtimeClass).add(runtimeClassStructureSize);
    // the size of a virtual table of this type (itself + the number of virtual methods
inherited)
    int vtableSize = runtimeClass.vtableSize;
    Method[ ] methods = new Method[vtableSize];
    // a staring memory address of the methods metadata array in Table 1
    Address methodsPointer = runtimeClassMethodIndexArrayAddress;
    for (int i=0; i < vtableSize; i++) {
      // methodIndex is an index of a function corresponding to this java
method in the Wasm table
      int methodIndex = methodsPointer.getInt( );
      methodsPointer = methodsPointer.add(4); // the point in Table 1 moves
by 4 bytes
      // reading method name, return type, params, etc., which is omitted herein
      // get method info and put method in TMethod[ ]
      Method method = new Method(this, methodIndex);
      methods[i] = method;
    }
    return methods;
  }
}
```

### Code Segment: 4

The above-mentioned code segment 4 is a pseudo-code specifically implemented by the Class.getMethod in the reflection library, and the reflection library where the code is located can be imported. This way, calls in user-written Java code can be replaced with code from the relevant reflection function that has been imported during the compilation process. In the above-mentioned code segment 4, the spliced function name on line 11 is used for traversing through the method object array of the type obtained in the code segment 4 until the first function with the same name string is matched, so that the index of the first function in Table 1 can be obtained.

The method for implementing Method.invoke( ) is, for example, as follows:

```
  Class Method{
    int funcIndex; // the Wasm function index of the packaged Java method, for example,
the getSum function index being 1
    Object invoke(Object obj, Object... args){
      switch(args.length){
        case 0: return call indirect(funcIndex);
        case 1: return call indirect(funcIndex, args[0]);
        case 2: return call indirect(funcIndex, args[0], args[1]);
        ...
        case n: return call_indirect(funcIndex, args[0], ... args[n−1]);
        ...
        }
    }
  }
```

### Code Segment: 5

The above-mentioned code segment 5 is the pseudo-code specifically implemented by the Method.invoke in the reflection library. In the above-mentioned code segment 2, the Class.getMethod( ) function on line 12 is used for obtaining the index of the first function in Table 1 that matches the name character string, which can be specifically obtained by the above-mentioned p.getClass( ).getMethod( ). The specific implementation of this function is the implementation in code segment 4 above. Furthermore, line 13 in the code segment 2 can be executed, i.e., calling the corresponding first function. Specifically, in the code segment 5, according to the number of the input parameters, under the condition of further verification that the number of parameters of the corresponding case is consistent with the corresponding number in Table 1, indirect calling is conducted. For example, the index of getSum in Table 1 is 1. Through line 12 in the code segment 2, it can be known that the index matching with the getSum character string in Table 1 is 1, so that two parameters input by the getSum function that initiates the calling are further verified through the switch sentence in the code segment 5, and it is obtained through verification that the funcIndex in case2 is 1 and the number of the parameters is also 2. In this way, indirect calling of the function with funcIndex of 1 can be initiated, i.e., in the following Table 3, through the index 1, searching the starting address of the getSum( ) function in the following Table 4, so as to be executed after the virtual machine parses the code of the corresponding starting address in Table 4.

The wasc file above can be deployed on the blockchain through the preceding process of deploying the contract. Furthermore, the deployed contract can be called. As stated above, the client may initiate a transaction for calling the contract, as the client 2 in FIG. 6, for example. The client may obtain the interface supported by the contract through searching an ABI of the contract in advance. For example, the client searches the ABI of the contract to obtain that the interface function includes sum(a). In this way, the client may initiate the transaction for calling the contract. The transaction for calling the contract may include the address of the called contract, the called function, and the input parameters (i.e., the input parameters). The called function and input parameters are located in the data field, for example, respectively, sum( ) and 1.

After consensus of the transaction for calling the contract, each blockchain node can execute the transaction. In some blockchain systems, some or all nodes can all first execute the transaction and then reach a consensus, which is not limited herein.

The blockchain node executes the transaction, specifically, including the virtual machine in the node to load and execute the bytecode of the called contract. The virtual machine may first load the Wasm file specifying the contract in the transaction to be executed, including the bytecode of the contract, and then explain and execute roughly according to the process shown in FIG. 4 above. The following would further describe the special points.

First, the contract may include an entrance function, through which, for example, a function like sum( ), 1 and the input parameter can be matched with the function in the contract. For example, the following codes:

```
  @ContractInterface // indicating the below being an exposed contract interface
  public int sum(int a) {
        int b = 1024;
      int sum = (Integer) getProperty(new Person( ), “Sum”, a, b);
    return sum;
  }
}
```

### Code Segment 6

In this way, sum( ), a is converted into the implementation of the getProperty( ). The input parameter of sum( ) can be different from that of getProperty( ), for example, the input parameter of sum( ) herein is a parameter a, while the input parameter of getProperty( ), in addition to the called object and called method name, are two parameters a and b. According to the above-mentioned code, one parameter a of the two arguments of the input parameters of getProperty( ) is the input parameter a of the sum( ) function, while the other parameter b of the two parameters of the input parameters of getProperty( ) can be set as a value set in the contract. This value can be a constant, and may also be a certain global variable. The latter, for example, is read from the contract state. In combination of the implementation defined on lines 10-14 in the code segment 2, the sum( ) can be converted into the function of getProperty( ) for processing.

As shown in FIGS. 5 and 6, the virtual machine loads the Wasm file of the called contract and executes the following process:

S210: create a linear memory region.

A physical memory is generally managed by an operating system, for example, in charge of establishing a mapping relationship between a logic address and a physical address. The Wasm virtual machine may maintain a linear memory region; the linear memory region is a part of the memory managed by the operating system, and is managed and controlled by the Wasm. Specifically, the Wasm can perform further abstraction on the basis of the memory managed by the operating system, to obtain a linear memory region with an address starting from, for example, 0, and can control the access to the linear memory according to an offset amount. As stated above, the Wasm virtual machine may further manage a part of non-linear memory, and the non-linear memory herein is referred to as the normal memory.

After loading the Wasm file, the Wasm virtual machine can create the linear memory region before executing the contract bytecode.

S220: use the metadata in the Wasm file to initialize at least a part of a memory in the linear memory region.

As stated above, the Wasm file includes the type and function metadata, and the contract bytecode. After loading the Wasm file, the Wasm virtual machine can create a linear memory region, so that the virtual machine can adopt the metadata of the first type and the first function included by the Wasm file to initialize at least part of the linear memory. As stated above, the address of the linear memory address may start from 0. The address in the operating system may be referred to as a base address of the linear memory; other addresses in the linear memory are equivalent to the offset amount with respect to the base address. In this way, for the address a in the linear memory, the memory address in the corresponding operating system is the base address of the linear memory in the operating system+the offset amount a in the linear memory. The Wasm virtual machine performs such an abstraction on the memory of the operating system, which facilitates the Wasm virtual machine to better manage and use the memory.

In this way, before executing the contract bytecode, the linear memory is nonempty, and before executing the contract bytecode instruction, the metadata about the constants, classes, and functions in the code are precontained in the linear memory, and the address in the linear memory is fixed, which facilitates deterministic calling when subsequently executing the Wasm bytecode.

In addition, as stated above, after the Wasm virtual machine loads the Wasm file, a normal memory region can further be created, so that the virtual machine can adopt a first function bytecode and a second function bytecode included in the Wasm file, to initialize at least a part of the normal memory. The function called by the object obtained according to the class instantiation during execution, is in a corresponding storage region of the class. The corresponding storage region of the class is generally located in the normal memory created by the virtual machine. That is to say, the function in the class is located in the normal memory region. The object created according to the class is the instantiation of the class, and when executing the function in the class, it needs to load from the normal memory and execute the corresponding function, including the first function and the second function.

After the virtual machine uses the first function to initialize at least a part of the normal memory, two tables can be generated respectively are a function table of Table 3 and a function code of Table 4.

The function table can be shown in the following table:

TABLE 3
function table in a normal memory

| | |
|---|---|
| an index of a function | function 1: a starting address of the |
| 1 in the table | function 1 in the normal memory; |
| an index of a function | function 2: a starting address of the |
| 2 in the table | function 2 in the normal memory; |
| an index of a function | function 3: a starting address of the |
| 3 in the table | function 3 in the normal memory; |
| . . . | . . . |

The function code can be shown in the following table:

TABLE 4
function code in a normal memory

| | |
|---|---|
| a starting address of the code of | the code of the function 1: |
| the function 1 in the memory | . . . |
| a starting address of the code of | the code of the function 2: |
| the function 2 in the memory | . . . |
| a starting address of the code of | the code of the function 3: |
| the function 3 in the memory | . . . |
| . . . | . . . |

For example, the first function includes function 1, function 2, function 3, . . . . As shown above, in Table 4, the code data block of function 1 is stored in the normal memory, and has a starting address in the normal memory managed by one virtual machine; similarly, the code data block of function 2 has a starting address in a normal memory, and the code data block of function 3 has a starting address in a normal memory. The function table in Table 3 may store the starting address of each function code in the normal memory in a short and regular format, for example, an address of 32 bits of each line in Table 3.

Hence, the first function in the first type above can include a plurality of functions. To facilitate to uniformly manage the functions in the first type in the memory, the starting address of each function in the normal memory in Table 4 can be filled in a corresponding position in Table 3, so as to be uniformly mapped to different function codes from this function table.

In the process of generating Table 3 by the virtual machine, the starting address of Table 3 in the normal memory can be obtained. In this way, according to the starting address and index of Table 3, the starting address of the corresponding function in Table 4 can be obtained.

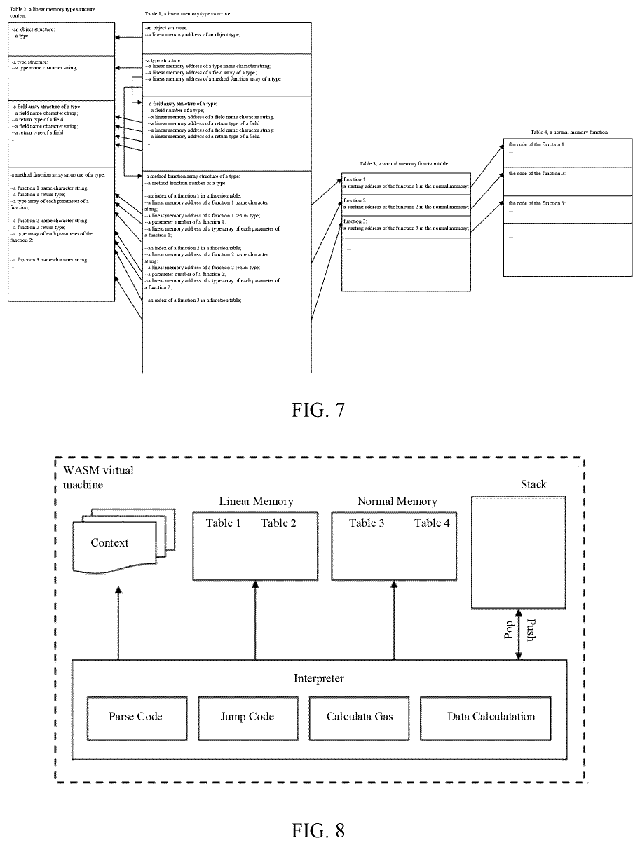

The combination of tables 1-4 above can form an integrated mapping table, which can be shown in FIG. 7. Tables 1 and 2 may be stored in the linear memory, and addresses thereof are determined when compiled by the compiler, and are fixed. Tables 3 and 4 are stored in the normal memory. A value of each item in the function of Table 3 may point to the starting address of the corresponding function code in Table 4. From the angle of the virtual machine, it can be shown in FIG. 8.

S230 parse and execute the contract bytecode in the Wasm file and when executing the bytecode of the second function, according to the dynamic parameters for function calling in the transaction that calls the contract, determine and execute, on the basis of the metadata, the called first function in the linear memory region.

In the process of loading the contract bytecode in the Wasm file in the virtual machine, the function in the class would also be loaded in the normal memory in the virtual machine, as the initializing process of the common function above. During running the Wasm bytecode, numeral value computing, memory reading and writing operations, function calling, and the like are involved. The memory operated by the Wasm bytecode is the linear memory created before running, and the normal memory cannot be directly operated. The normal memory can be operated by the virtual machine, so that it can be ensured that the contract bytecode would not directly modify the function bytecode in the normal memory.

The virtual machine parses and executes the contract bytecode in the Wasm file, and the execution is conducted according to the logic in the contract bytecode. When executing the reflection code in the second function bytecode, the actually called function can be dynamically determined according to the dynamic parameters of the called function in the transaction that calls the contract. Specifically, when executing the bytecode of the second function: when executing line 11 in the code segment 2 above, the function name is spliced; when executing line 12 (actually also including the content of the replaced code segment 4), the function name spliced on line 11 is used for traversing in the virtual table, until the first function having the same name character string is matched, so as to obtain the index of the first function in Table 1; when executing line 13 in the code segment 2 (actually also including the content of the replaced segment 5), the corresponding first function is called. Specifically, in the code segment 5, according to the number of the input parameters, under the condition of further verification that the number of parameters of the corresponding case is consistent with the corresponding number in Table 1, indirect calling is conducted. For example, the index of getSum in Table 1 is 1. Through line 12 in the code segment 2 (the content of the replaced segment 4), it can be known that the index matching with the getSum character string in Table 1 is 1, so that two parameters input by the getSum function that initiates the calling are further verified through the switch sentence in the code segment 5, and it is obtained through verification that the funcIndex in case2 is 1 and the number of the parameters is also 2. In this way, indirect calling of the function with funcIndex of 1 can be initiated, i.e., in the following Table 3, through the index 1, searching the starting address of the getSum( ) function in the following Table 4, so as to be executed after parsing the code of the corresponding starting address in Table 4.

Similarly, for example, the index of getMultiply in Table 1 is 2. Through line 12 in the code segment 2 (the content of the replaced segment 4), it can be known that the index matching with the getMultiply character string in Table 1 is 2, so that two parameters input by the getMultiply function that initiates the calling are further verified through the switch sentence in the code segment 5, and it is obtained through verification that the funcIndex in case2 is 2 and the number of the parameters is also 2. In this way, indirect calling of the function with funcIndex of 2 can be initiated, i.e., in the following Table 3, through the index 2, searching the starting address of the getMultiply( ) function in the following Table 4, so as to be executed after parsing the code of the corresponding starting address in Table 4.

The above-mentioned example can implement, according to a function name character string for function calling in the transaction that calls the contract, determining and executing, on the basis of the metadata, the called first function in the linear memory region. In addition to the spliced character string described above, the user-input character string can also be used, or the character string obtained and from construction from the integer or binary.

In the embodiments above, a reflection function can be implemented in the Wasm file, such that when a Wasm program is running, capabilities such as accessing, detecting, and modifying own states or behaviors can be implemented. This is particularly useful when there are multiple functions, as it allows developers to easily and flexibly use reflection to call different functions while developing the contract. For example, the developers may develop Java source code including the reflection programming function. The reflection programming is, for example, obtaining the type of a certain object, and the obtained type includes which fields, which methods, etc. Specifically, the blockchain platform vendors can provide auxiliary functions that are, for example, located in a reflection library. The auxiliary functions may include some APIs that obtain type and function metadata. The function library may be provided to the developers, so that the developers can include the library function into the source code during the process of using the high-level languages to develop the smart contract, and the class API in the function library is called in the source code, so that through the auxiliary functions in the source code, the function of obtaining the type and function metadata is achieved. In addition, the original function library can also be adopted, for example, the function library providing a reflection programming function included in the Java itself, and therefore, the developers can introduce the reflection programming function provided by the function library during the process of developing the source code using the Java language.

As mentioned above, for the smart contract edited in Java language, the contract developer can generate a corresponding source file after writing the smart contract, which is generally a source file with an extended name java. The java file of the contract code can be compiled by the compiler to generate bytecode in the Wasm format. The contract bytecode in the Wasm format can be packaged in the wasc file. In addition, it is also possible to develop and complete the Java bytecode in other blockchain systems supporting the reflection function, such as a file with an extended name .class, and therefore, the Java bytecode includes the code having the reflection function. Such as Java bytecode is an equivalent program of the Java source code, and therefore, the compiler in the embodiments of this specification can also be used for further compiling such a Java bytecode having the reflection function, so as to generate the Wasm bytecode. Therefore, the generated Wasm bytecode also has the reflection function, so that the reflection function can be implemented when the virtual machine executes the Wasm bytecode.

In addition, as stated above, the high-level languages having the reflection programming function further include C#, Python, Go, and other languages, in addition to Java. However, for some contract codes developed by programming languages themselves not supporting the reflection mechanism, the reflection function can also be implemented through the reflection library, complier, and the virtual machine provided by this specification, such as C++ and other languages.

On the basis of the aforementioned solution, embodiments of this specification further provide a compiling method, which includes: in a process that a compiler compiles contract source code that includes reflective programming into a Wasm file: according to code that defines a first type in source code/bytecode, generating metadata of the first type and a first function in the first type, and packaging the generated metadata of the first type and the first function in the first type in the Wasm file; and according to reflection code in the source code, generating contract bytecode of a second function that obtains a first function type and first function content according to dynamic parameters during running.

On the basis of the aforementioned solution, embodiments of this specification further provide a method for executing the Wasm file compiled by the preceding compiling method by a Wasm virtual machine, which includes the Wasm virtual machine loading a Wasm bytecode of the called contract, and including creating a linear memory region; using the metadata in the Wasm file to initialize at least a part of a memory in the linear memory region; and parsing and executing the contract bytecode in the Wasm file and when executing the bytecode of the second function, according to the dynamic parameters for function calling in the transaction that calls the contract, determining and executing, on the basis of the metadata, the called first function in the linear memory region.

The method further includes: creating a normal memory region, and adopting a first function bytecode and a second function bytecode comprised in the Wasm file, to initialize at least a part of a normal memory.

For the method, the adopting a first function bytecode and a second function bytecode included in the Wasm file, to initialize at least a part of a normal memory, includes: generating a function table and a function code in the normal memory, where the function table stores a memory starting address where the function code is located.

Based on the aforementioned solution, the embodiment of this specification further provides a compiler, which includes: a metadata generating unit, configured to generate, according to code that defines a first type in source code/bytecode, metadata of the first type and a first function in the first type; a packaging unit, configured to package the generated metadata of the first type and the first function in the first type generated by the metadata generating unit in the Wasm file; and a second function contract bytecode generating unit, configured to generate, according to reflection code in the source code, contract bytecode of a second function that obtains a first function type and first function content according to dynamic parameters during running.

Based on the aforementioned solution, the embodiment of this specification further provides a Wasm virtual machine, which is configured to execute the Wasm file complied by the preceding compiler, and includes: a loading unit, configured to load a Wasm bytecode of the called contract, and including: a creating unit, configured to create a linear memory region; a first initializing unit, configured to use the metadata in the Wasm file to initialize at least a part of a memory in the linear memory region; and an execution unit, configured to parse and execute the contract bytecode in the Wasm file and when executing the bytecode of the second function, according to the dynamic parameters for function calling in the transaction that calls the contract, determine and execute, on the basis of the metadata, the called first function in the linear memory region.

Based on the aforementioned solution, the embodiment of this specification further provides a blockchain node for executing a smart contract includes the Wasm virtual machine or executes the aforementioned method.

Based on the aforementioned solution, the embodiment of this specification further provides a blockchain node for executing a smart contract includes: a processor, and a memory storing a program, where the aforementioned method is executed when the process executes the program.

In the 1990s, it was clear whether an improvement of a technology was a hardware improvement (for example, an improvement of the circuit structure such as diodes, transistors, and switches) or a software improvement (an improvement of the method flow). However, with the development of technology, the improvement of many methods can be regarded as a direct improvement of the hardware circuit structure. Almost all designers get the corresponding hardware circuit structure by programming the improved method flow into the hardware circuit. Hence, it cannot say that an improvement of a method flow cannot be implemented using a hardware entity module. For example, a Programmable Logic Device (PLD), such as a Field Programmable Gate Array (FPGA), is such an integrated circuit whose logic functions are determined by the user programming the device. By the designer's own programming to “integrate” a digital system on a PLD, without asking the chip manufacturer to design and produce a special integrated circuit chip. Moreover, now, instead of manually making an integrated circuit chip, this programming is mostly executed with “logic compiler” software, which is similar to a software compiler used when the program is developed, and the original code before it is compiled also has to be written in a specific programming language, which is referred to as Hardware Description Language (HDL), and there is not just one HDL, but many HDLs, such as Advanced Boolean Expression Language (ABEL), Altera Hardware Description Language (AHDL), Confluence, Cornell University Programming Language (CUPL), HDCal, Java Hardware Description Language (JHDL), Lava, Lola, MyHDL, PALASM, and Ruby Hardware Description Language (RHDL). Very-High-Speed Integrated Circuit Hardware Description Language (VHDL) and Verilog are the most commonly used currently. Persons skilled in the art should also know that only by using the above-mentioned hardware description languages to perform a little logic programming on the method flow and programming same into the integrated circuit, the hardware circuit for realizing the logic method flow can be easily obtained.

The controller can be implemented in any appropriate way, for example, the controller may be in the form of, for example, a microprocessor or processor and a computer readable medium, logic gates, switches, an Application Specific Integrated Circuit (ASIC), programmable logic controllers, and embedded microcontrollers, which store the computer readable program code (for example, software or firmware) that can be executed by the (micro) processor. Examples of the controller include, but are not limited to, the following microcontrollers: ARC 625D, Atmel AT91SAM, Microchip PIC18F26K20, and Silicone Labs C8051F320. The memory controllers can also be implemented as part of the memory control logic. It is also known to persons skilled in the art that, in addition to implementing the controller in a purely computer-readable program code manner, it is entirely possible to perform the same functions of the controller in the form of logic gates, switches, ASIC, programmable logic controllers, embedded microcontrollers and the like by logic programming the method steps. Hence, this controller can be considered to be a hardware component, while an apparatus included therein for implementing various functions can also be considered as the structure in the hardware component. Or the apparatus for implementing various functions can even be considered as both a software module for implementing a method and the structure in the hardware component.

The system, apparatus, module, or unit stated in the embodiments above can specifically be implemented using a computer chip or entity, or may be implemented by a product having a certain function. A typical implementing device is a server system. Of course, this specification does not exclude that with the development of computer technology in the future, the computer that implements the functions of the above-mentioned embodiments may, for example, be a personal computer, a laptop computer, a vehicular human-computer interaction device, a cellular phone, a camera phone, a smart phone, a personal digital assistant, a media player, a navigation device, an E-mail device, a game console, a tablet computer, a wearable device, or a combination of any of these devices.

Although one or more embodiments of this specification provide method operating steps as described in an embodiment or a flowchart, more or fewer operating steps may be included on the basis of conventional or noncreative means. The sequence of steps enumerated in the embodiments is only one way among multiple step execution sequences and does not represent a unique sequence of execution. When executed in an actual apparatus or end product, it may be executed sequentially or in parallel in accordance with the method sequence shown in the embodiments or the accompanying drawings (for example, a parallel processor or multithreaded processing environment, or even a distributed data processing environment). The term “include”, “comprise”, or any other variation thereof is intended to cover non-exclusive inclusion, such that a process, method, product, or device including a set of elements includes not only those elements but also other elements not explicitly listed, or elements inherent to such a process, method, product, or device. Without further limitations, it does not preclude the existence of additional identical or equivalent elements in the process, method, product or device including such elements. For example, if the words first, second, and the like are used for indicating names, they do not indicate any particular order.

For the convenience of description, the above-mentioned apparatuses are divided into various modules according to functions for respective descriptions. Of course, when implementing one or more of this specification, functions of various modules can be realized in the same or more software and/or hardware, and the modules that achieve the same function can also be realized by a combination of multiple sub-modules or sub-units. The apparatus embodiments described above are only schematic, for example, the division of units is only a logical function division; in actual implementation, there may be other ways of division; for example, multiple units or assemblies can be combined or can be integrated into another system, or some features can be omitted, or not performed. On the other hand, the coupling or direct coupling or communicative connection between each other shown or discussed may be indirect coupling or communicative connection through some interfaces, apparatuses or units, and may be in electrical, mechanical or other forms.

The present invention is described with reference to the flowchart and/or block charts of methods, apparatuses (systems), and computer program products according to the embodiments of the present invention. It should be understood that each process and/or box in a flowchart and/or block chart, and combinations of processes and/or boxes in the flowchart and/or block chart, can be implemented by computer program instructions. These computer program instructions can be provided to processors of a general-purpose computer, a special purpose computer, an embedded processor, or other programmable data processing devices, to produce a machine, so that the instructions executed by the processors of the computer or other programmable data processing devices generate an apparatus for implementing functions specified in one or more processes of a flowchart and/or one or more boxes of a block chart.

These computer program instructions can also be stored in a computer-readable memory that can guide a computer or another programmable data processing device to operate in a particular manner, such that the instructions stored in the computer readable memory produce an article of manufacture including an instruction apparatus, and the instruction apparatus implements the functions specified in the one or more processes of the flowchart and/or the one or more boxes of the block chart.

These computer program instructions can also be loaded to a computer or another programmable data processing device, so that a series of operating steps are executed on the computer or another programmable data processing device, to generate the processing implemented by the computer, and therefore, the instructions executed on the computer or another programmable data processing device provide steps of implementing the functions specified in the one or more processes of the flowchart and/or the one or more boxes of the block chart.

In a typical configuration, a computing device comprises one or more processors (CPUs), an input/output interface, a network interface, and a memory.

The memory may include non-permanent memory in a computer readable medium, random access memory (RAM), and/or non-volatile memory, and other forms, such as read-only memory (ROM) or flash memory (flash RAM). The memory is an example of the computer readable medium.

The computer readable medium includes permanent and non-permanent, removable and non-removable media, which can store information by any method or technology. The information may be a computer-readable instruction, a data structure, a program module, or other data. Examples of the computer storage media include, but not limited to phase change memory (PRAM), static random access memory (SRAM), dynamic random access memory (DRAM), other types of random access memories (RAMs), read-only memory (ROM), electrically erasable programmable read-only memory (EEPROM), flash memory, or other memory technology, read-only optical disc read-only memory (CD-ROM), digital multi-purpose optical disc (DVD) or other optical storage, magnetic cassette, magnetic tape disk storage, graphene storage or other magnetic storage devices or any other non-transmission medium that may be used for storing information that can be accessed by computing devices. As defined herein, the computer-readable media do not include transitory computer-readable media, such as modulated data signals and carriers.

Persons skilled in the art should know that one or more embodiments of this specification can be provided as a method, a system, or a computer program product. Hence, the one or more embodiments of this specification can adopt forms of fully hardware embodiments, fully software embodiments, or embodiments combining software and hardware aspects. Moreover, the one or more embodiments of this specification may use the form of a computer program product implemented on one or more computer available storage media (including, but not limited to, disk storage, CD-ROM, optical memory, etc.), wherein the computer available program code is included.

The one or more embodiments of this specification may be described in a common context of a computer executable instruction executed by a computer, for example, a program module. Generally, the program module includes routines, programs, objects, assemblies, data structures, and so on that perform specific tasks or implement specific abstract data types. The one or more embodiments of this specification may also be practiced in a distributed computing environment where tasks are performed by remote processing devices that are connected through a communication network. In the distributed computing environment, the program module can be located in local and remote computer storage media, including the storage devices.

Each embodiment in this specification is described in a progressive manner, same and similar parts between each embodiment can be referred to by one other, and each embodiment focuses on differences from other embodiments. In particular, for system embodiments, because they are basically similar to method embodiments, the description is relatively simple, and the relevant features can be seen in the partial description of the method embodiments. In the description of this specification, references to term “an embodiment”, “some embodiments”, “examples”, “specific examples”, or “some examples” mean that specific features, structures, materials, or characteristics described in conjunction with this embodiment or example are included in at least one embodiment or example of this specification. In this specification, it is unnecessary for the explanatory representation of the above-mentioned terms to refer to the same embodiment or example. Moreover, the specific features, structures, materials, or characteristics described may be combined in any one or more embodiments or examples in a suitable manner. In addition, without contradicting each other, persons skilled in the art may combine and integrate different embodiments or examples described in this specification and features of the different embodiments or examples.

The above-mentioned contents are only embodiments of one or more embodiments of this specification and are not intended to limit the one or more embodiments of this specification. For persons skilled in the art, the one or more embodiments of this specification may have various modifications and changes. Any modification, equivalent substitution, improvement, etc. made within the spirit and principle of this specification shall all be included in the scopes of the claims.

What is claimed is:

1. A method for implementing a reflection mechanism in a blockchain, comprising:
in a process that a compiler compiles contract source code that comprises reflective programming into a Wasm file:
according to code that defines a first type in the contract source code or bytecode, generating, by the compiler, metadata of the first type and a first function in the first type;
packaging, by the compiler, the metadata of the first type and the first function in the first type in the Wasm file; and
according to reflection code in the contract source code, generating, by the compiler, contract bytecode of a second function that obtains a first function type and first function content according to dynamic parameters during running; and
after receiving a transaction that calls a contract, loading, by a virtual machine, the Wasm file of the contract;
creating, by the virtual machine, a linear memory region;
using, by the virtual machine, the metadata in the Wasm file to initialize at least a part of a memory in the linear memory region; and
parsing and executing, by the virtual machine, the contract bytecode in the Wasm file; and
when executing the contract bytecode of the second function, according to the dynamic parameters for function calling in the transaction that calls the contract, determining and executing, by the virtual machine based on the metadata, the first function in the linear memory region.

2. The method of claim 1, wherein the metadata comprises a structure of a first type object and a structure of the first function.

3. The method of claim 2, wherein the structure of the first type object in the metadata comprises:
a linear memory address of an object type; and
a linear memory address of each field array of an object.

4. The method of claim 2, wherein the structure of the first function in the metadata comprises:
a method function number of a type;
an index of a function in a function table;
a linear memory address of a function name character string;
a linear memory address of a function return type;
a parameter number of a function; and
a linear memory address of a type array of each parameter.

5. The method of claim 2, wherein the metadata further comprises at least one of a first type structure or a field structure of a first type.

6. The method of claim 5, wherein the first type structure in the metadata comprises:
a linear memory address of a type name character string;
a linear memory address of a field array of a type; and
a linear memory address of a method function array of a type.

7. The method of claim 5, wherein the field structure of the first type in the metadata comprises:
a field number of a type;
a linear memory address of a field name character string; and
a linear memory address of a return type of a field.

8. The method of claim 1, wherein the according to reflection code in the contract source code or bytecode, generating, by the compiler, contract bytecode of a second function that obtains a first function type and first function content according to dynamic parameters during running, comprises:
based on a reflection library imported in the contract source code or the bytecode and according to reflection code in the contract source code or the bytecode, generating, by the compiler, the contract bytecode of the second function that obtains the first function type and the first function content according to the dynamic parameters during running.

9. The method of claim 1, wherein after loading the Wasm file of the contract, the method further comprises creating, by the virtual machine, a normal memory region.

10. The method of claim 9, wherein the method further comprises adopting, by the virtual machine, a first function bytecode and a second function bytecode comprised in the Wasm file, to initialize at least a part of a normal memory.

11. The method of claim 10, wherein the adopting, by the virtual machine, a first function bytecode and a second function bytecode comprised in the Wasm file, to initialize at least a part of a normal memory, comprises:
generating, by the virtual machine, a function table and a function code in the normal memory, wherein the function table stores a memory starting address where the function code is located.

12. The method of claim 1, wherein the according to the dynamic parameters for function calling in the transaction that calls the contract, determining and executing, by the virtual machine based on the metadata, the first function in the linear memory region, comprises:
according to a function name character string for the function calling in the transaction that calls the contract, determining and executing, by the virtual machine based on the metadata, the first function in the linear memory region.

13. A method for compiling contract source code that comprises reflective programming into a Wasm file, comprising:
according to code that defines a first type in the contract source code or bytecode, generating metadata of the first type and a first function in the first type;
packaging the metadata of the first type and the first function in the first type in the Wasm file; and
according to reflection code in the contract source code, generating contract bytecode of a second function that obtains a first function type and first function content according to dynamic parameters during running.

14. The method of claim 13, wherein the metadata comprises a structure of a first type object and a structure of the first function.

15. The method of claim 14, wherein the structure of the first type object in the metadata comprises:
a linear memory address of an object type; and
a linear memory address of each field array of an object.

16. The method of claim 14, wherein the structure of the first function in the metadata comprises:
a method function number of a type;
an index of a function in a function table;
a linear memory address of a function name character string;
a linear memory address of a function return type;
a parameter number of a function; and
a linear memory address of a type array of each parameter.

17. The method of claim 14, wherein the metadata further comprises at least one of a first type structure or a field structure of a first type.

18. A method for executing a Wasm file compiled from contract source code that comprises reflective programming by a process comprising:
according to code that defines a first type in the contract source code or bytecode, generating metadata of the first type and a first function in the first type;
packaging the metadata of the first type and the first function in the first type in the Wasm file; and
according to reflection code in the contract source code, generating contract bytecode of a second function that obtains a first function type and first function content according to dynamic parameters during running, and
wherein the method comprises:
after receiving a transaction that calls a contract, loading the Wasm file of the contract;
creating a linear memory region;
using the metadata in the Wasm file to initialize at least a part of a memory in the linear memory region;
parsing and executing the contract bytecode in the Wasm file; and
when executing the bytecode of the second function, according to the dynamic parameters for function calling in the transaction that calls the contract, determining and executing, based on the metadata, the first function in the linear memory region.

19. The method of claim 18, further comprising:
creating a normal memory region; and
adopting a first function bytecode and a second function bytecode comprised in the Wasm file, to initialize at least a part of a normal memory.

20. The method of claim 19, wherein the adopting a first function bytecode and a second function bytecode comprised in the Wasm file, to initialize at least a part of a normal memory, comprises:
generating a function table and a function code in the normal memory, wherein the function table stores a memory starting address where the function code is located.
